(19) United States
(12) Patent Application Publication
(10) Pub. No.: US 2007/0118749 A1
(43) Pub. Date: May 24, 2007

(54) Method for providing services in a data transmission network and associated components

(75) Inventors: Christine Hagn, Neufahrn (DE); Per Kaijser, Ismaning (DE); Wernhard Markwitz, Munchen (DE)

Correspondence Address: MORRISON & FOERSTER LLP, 1650 TYSONS BOULEVARD, SUITE 400, MCLEAN, VA, 22102, US

(73) Assignee: SIEMENS AG SIEMENS AKTIENGESELLSCHAFT, MUNCHEN (DE)

(21) Appl. No.: 10/478,416

(22) PCT Filed: May 7, 2002
(86) PCT No.: PCT/DE02/01646

§ 371 Date: Apr. 26, 2004

(30) Foreign Application Priority Data
May 22, 2001 (DE) 101 25 017.7

(51) Int. Cl. H04L 9/00

(52) U.S. Cl. 713/173; 705/67; 705/75; 705/40

(57) ABSTRACT

The invention relates to, among other things, a method according to which an access function (36) for a number of service user computers (18) permits a connection between the service user computer (18) and a service provider computer (22 to 26), which is selected by a service user (A), according to requests submitted by a service user computer (18). The insertion of an access function (36), and the use of a test unit (38) make it possible to secure useful data that is to be processed in a reliant manner.

### CLAIM FOR PRIORITY

This application claims priority to International Application No. PCT/DE02/01646 which was published in the German language on Nov. 28, 2002.

### TECHNICAL FIELD OF THE INVENTION

The invention relates to a method whereby an access function for several service user computers enables a connection between the service user computer and a service provider computer. More specifically, with the aid of an access function, the Internet page of a business that sells its services on the Internet can be called up and the access function checks, among other things, the identity of the service user, for example, by requesting a password.

### BACKGROUND OF THE INVENTION

Until now, it has been usual for each business to have its own access function and for the customer data of each business to be stored individually, and therefore several times under certain circumstances. The security of customer data where storage of customer data is distributed in this way can be guaranteed only to a limited extent. Because of these limitations with regard to security, a trade in customer data has developed. Such trade substantially reduces the acceptance of providing services through the Internet, particularly if customer data is used in conjunction with the purchasing power, credit limit or other financial data of the customer.

### SUMMARY OF THE INVENTION

According to an aspect of the invention, a simpler method of providing services in a data transmission network, that particularly guarantees to protect customer data from misuse better than previous methods, is provided. Furthermore, an associated program and associated data processing system are also specified.

According to a further aspect of the invention, the substantial expense required to secure customer data is considered, which would reduce acceptance of the provision of services through the Internet on the part of the service provider. But to counteract this, an access function is provided that enables a connection between a service user computer and a service provider computer that can be selected from several by a service user. Furthermore, a central database may be set up in which user data to be secured for the various service users is stored, that is necessary for the provision of the services of various service provider computers. By this centralization of the access function and the database, the cost for securing customer data can be spread over a number of different service providers. The acceptance on the part of the service provider thus increases.

By using the central database, the service user can also be assured that his data is protected against misuse. This thus increases the acceptance by the service user of the method of providing a service by a data transmission network.

The method in accordance with an aspect of the invention is also based on the consideration that secure customer data is in fact necessary as part of the service provision, but does not necessarily have to be provided to the service provider.

Therefore, the method in accordance with an aspect of the invention of providing a connection between a service user computer and a selected service provider computer as part of the provision of a service requires a central test unit for the service user using the service user computer. This requirement, for example, includes the assurance of the ability of the service user to pay. The request can be processed only by access to the secure user data of the service user. Thus, for example, cover notes from a bank are to be stored for subsequent verification purposes. On the other hand, an earlier cover note can also be read provided it is still valid. A test unit that works independently of the service provider computers processes the requirement by access to the secure user data of the service user. Only the result of the processing, but not the secure user data itself, is communicated by the test unit to the service provider computer making the request. The relevant service provider computer then provides its service depending on the result of the processing. This procedure therefore means that the secure customer data itself does not have to be communicated to a service provider computer. Only the test unit has access to the secure data. Therefore, trading with the secure customer data is hindered and misuse is effectively prevented.

According to a further aspect of the invention, the service provider computers belong to different operators. After a service provider computer has been selected, its authority to make requests is checked by an authorization check procedure. The result of the processing is communicated by the test unit to the service provider computer only if authorization is present. If authorization is absent, no processing result is communicated. The request must not be processed if authorization is absent. Checking the authorization on the part of the service provider computer means that it can be guaranteed that no requests are made by unauthorized persons who could then misuse the results of the processing.

According to another aspect of the invention, the secure user data is stored encrypted. The service provider computers have no access to a digital key required for encryption. The encryption procedure, or a key to be used, can be kept secret by structural and/or electronic security measures. Even if the secure customer data is copied by unauthorized persons, such persons are not in possession of the key required for decryption. The secure data thus remains protected against misuse despite the unauthorized copying.

According to another aspect of the invention, service user data containing service-related data for the service users of individual service provider computers is stored in a database. After a service provider computer is selected, its authorization to receive service user data relative to the service it provides is checked. The requested service user data is communicated to the selected service provider computer only where authorization exists. Only the service-related data of the particular service user that has selected the selected service provider computer is communicated. The service provider computer then provides its service by using the communicated service user data. By checking the authorization to receive service user data, it can be guaranteed that the service user data of individual service providers is not improperly communicated to third parties.

According to another aspect of the invention, the database for storing the service user data is part of the central database. In yet another aspect of the invention, the same method of checking is used for checking the authorization for making requests and for checking the authorization for receiving service-related service user data. Thus, only one authorization check procedure has to be carried out in each case.

In a development of the method with a database for service user data, the service user data is stored encrypted and is also transmitted encrypted. Different service provider computers use different digital keys for decrypting the service user data. This measure guarantees that the service user data can be decrypted only by the authorized service provider. Other service provider computers, and also the operator of the databases, are not able to decrypt the service user data. This thus effectively protects the service user data from misuse. The storage of the service user data outside the business providing the service is thus accepted more readily.

According to a further aspect of the invention where service user data is used, the service user data is additionally or alternatively encrypted by a central encryption process. A digital key to which the service provider computer has no access is used for decrypting the user data encrypted using the central encryption process. In this way, both the unencrypted data from the service provider computers and encrypted data can be securely stored using the same central process. A double encryption also offers additional security against the misuse of service-related data.

According to a further aspect of the invention, digital data regarding payment procedures for different service provider computers is stored in a database used by several service -provider computers. This database is, for example, part of the central database. The aforementioned encryption process can also be used to secure data regarding payment procedures. Furthermore, an authorization check is carried out before the data on payment procedures is transmitted.

According to yet another aspect of the invention, the authorization of the service user is checked by using an authorization check procedure. The selection is permitted only if authorization is present. This authorization check prevents misuse by the service user.

In another aspect of the invention, the authorization check(s) is/are carried out using digital keys that have been generated by at least one certification center. The certification center itself is part of a certification chain. Compared with using passwords, the use of digital keys offers an increased safety, and an additional safety if passwords are additionally used. A certification infrastructure can, for example, be set up in accordance with standard X.509 of the ITU-T (International Telecommunication Union—Telecommunication Sector). Other infrastructures are also used, such as an infrastructure in accordance with the specifications of the IETF (Internet Engineering Task Force) in Request for Comment 2459, January 1999. Setting up such infrastructures and including them in the method in accordance with the invention guarantees a high degree of security for all participating sides. For example, invalid keys can be easily blocked.

According to still a further aspect of the invention, a secret digital key can be used for encryption. The secret key is stored in a secure electronic storage unit. In one embodiment, the secure storage unit is part of a chip card containing an embedded processor and a secure storage unit. It is possible to read from, and write to, the secure storage unit by this processor. In another embodiment, an authorization check is carried out before access, that for example contains a request for a password or secret number. Preferably, an asymmetric coding method is used.

According to a further aspect of the invention, the request refers to securing a payment. Securing payment is the core of the service provision using a data transmission network and is therefore particularly important for the acceptance of this method. There is therefore a requirement that a third party accepts responsibility if the service user does not pay for the service used. With one embodiment, these guarantees are time-limited, e.g. to one day or to the duration of a connection between the service user and service provider computer.

According to a further aspect of the invention, the test unit requests receipt of a payment certificate to a certification computer when processing the request. The certification computer generates a digital payment certificate that guarantees the payment. The payment certificate is then passed on through the test unit to the service provider computer. In one embodiment, encryption and/or signature methods using digital keys are also used to generate the digital payment certificate. Also, in one embodiment, the certification computer is part of a certification infrastructure. The certificates generated by the certification computer have a shorter period of validity than the certificates for the digital keys. Misuse of the payment certificate or payment attribute is better prevented by the short period of validity. A certification computer in one embodiment is a TrustedA (Trusted Authorizer) computer, such as is sold by the Irish company SSE, see www.sse.ie.

According to an alternative aspect of the invention, the test unit itself generates a payment certificate that guarantees payment when processing the request. In this case, the test unit is, for example the property of a banking institute or credit institute. The payment certificate generated by the test unit is also passed on to the service provider computer. The service provider computer then, for example, checks the payment certificate and initiates the provision of the service, provided the payment certificate is valid and the request is confirmed.

In another aspect of the invention, the service providers perform the functions of electronic sales platforms and/or electronic service platforms, e.g.
calling up music data, video data or program data,
e-business, banking transactions, commercial transactions,
information services
secure digital voice transmission.

In this way, the access function offers the service user access, for example to a virtual shopping mall. The method in accordance with the invention is, however, also used for other services where secure data of the service user is part of the service provision, for example credit businesses.

The invention also relates to a program with a sequence of instructions, the execution of which by a processor is performed by the method in accordance with the different aspects of the invention. Furthermore, a data processing system containing such a program is protected. The aforementioned technical actions therefore apply for the program and the data processing system.

Asymmetric methods of encryption, e.g. the RSA method (Revist, Shamir, Adleman) can be used for encryption. Symmetric methods, such as the triple DES (Data Encryption Standard) algorithm can also be used. Another common encryption method is, for example, the ECC (Elliptic Curve Cryptography) method.

### BRIEF DESCRIPTION OF THE DRAWINGS

Exemplary embodiments of the invention are explained in the following using the accompanying drawings. These are as follows.

FIG. 1 shows a data transmission network and a central computer;

FIG. 2 shows a process for providing a “book purchasing” service;

FIG. 3 shows a process of an ability-to-pay request; and

FIG. 4 shows a process of an attribute enquiry.

### DETAILED DESCRIPTION OF THE PREFERRED EMBODIMENTS

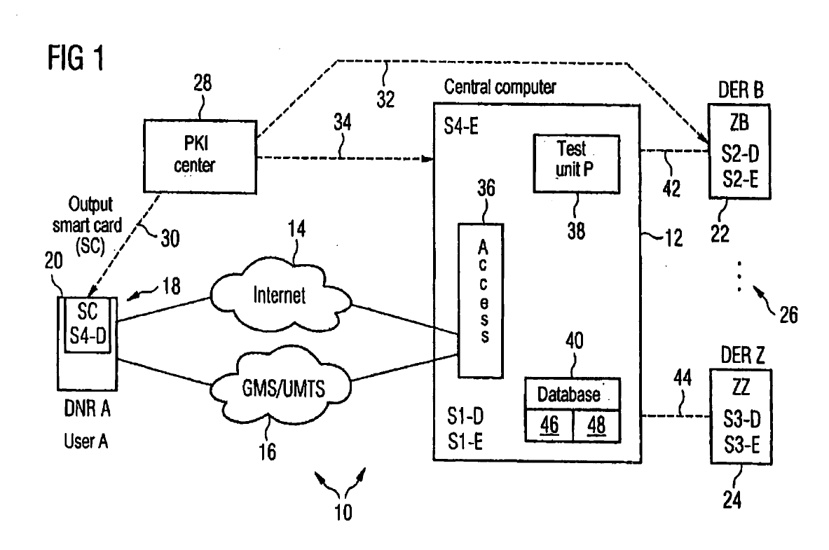

FIG. 1 shows a data transmission network 10 containing a central computer 12. The Internet 14 and a mobile radio network 16 are also part of the data transmission network 10. Digital data in accordance with the TCP/IP (Transmission Control Protocol/Internet Protocol) protocol is transmitted on the Internet 14. Digital data, for example in accordance with the GSM standard (Global System for Mobile Communication) or in accordance with the UMTS standard (Universal Mobile Telecommunication System) is transmitted in the mobile radio network 16.

Through the Internet 14 or the mobile radio network 16, a number of service users, for example several thousand, can establish connections between the terminals used by them and the central computer 12. FIG. 1 shows the terminal 18 of a service user A. The terminal 18 is, for example, a portable computer or a mobile radio device and contains a smart card 20.

Connections can also be established between a number of service provider computers and the central computer 12 through the Internet 14 and mobile radio network 16. In the example, several hundred service provider computers are registered with the central computer 12. FIG. 1 shows two service provider computers 22 and 24 belonging to the service providers B and Z. Further service provider computers 26 are indicated by dots. Various digital certificates ZB or ZZ are stored separately from each other, in each case in the service provider computers 22 and 24.

The smart card 20, the certificate ZB and the certificate ZZ are output from a PKI (Public Key Infrastructure) center 28 after the identity of the service user A, the service provider B or service provider Z has been checked by a local issuing center. The local issuing center is also known as an LRA (Local Registration Authority) center. The issue of the smart card 20 or certificate ZB is indicated by an arrow 30 or 32.

If the smart card 20 or a certificate ZB, ZZ is blocked, the PKI center 28 informs the central computer 12 (see arrow 34). The central computer 12 then precludes the invalid smart card 20 or invalid certificate ZB, ZZ from further transactions during authorization checks.

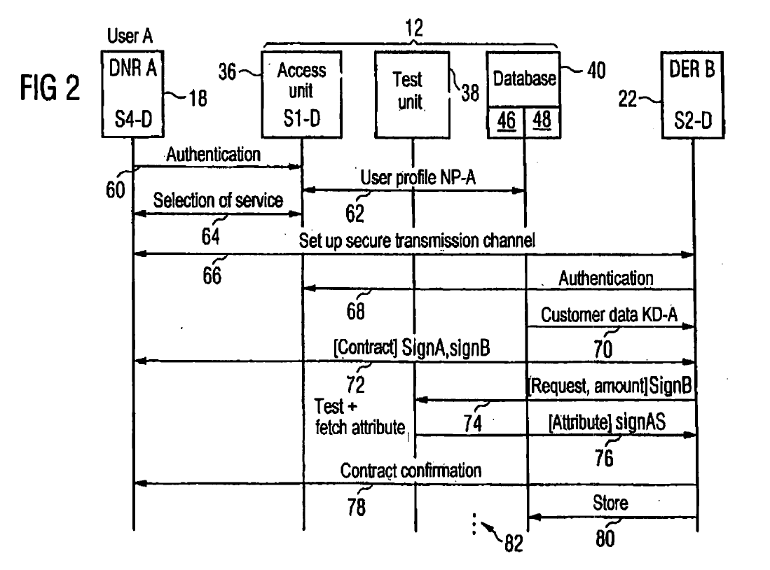

The central computer 12 should be a very powerful computer and contains an access unit 36, a test unit 38 and a database 40. The access unit 36 provides an access facility for the service user computer 18 and is connected to the Internet 14 and mobile radio network 16. Connections between the central computer 12 and the service provider computers 22 to 26 can also be established via the access unit 36, see connections 42 and 44. The access unit 36 also performs authorization checks; these are explained in more detail using FIG. 2.

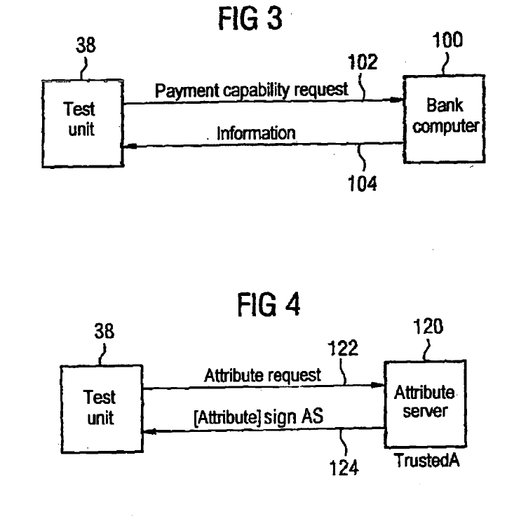

The test unit 38 preferably checks whether, for a service user, the guarantee that he is capable of paying can be accepted. To do this, a payment attribute is generated. The method performed for this are explained further using FIGS. 3 and 4.

The access unit 36 and test unit 38 have access to the database 40. Service user profiles 46 and service user data 48 are stored in the database 40. The database 40 is administered by a commercially available directory administration program, e.g. the DIRX program from SIEMENS AG. The service user profiles 46 contain data on the habits of the service user when selecting the service provider computers 22 to 24. Furthermore, the service user profiles 46 contain, for example, details of the credit limit up to which the operator of the central computer accepts the guarantee of the payment capability by the service user. Depending on the service involved, the service user data 48 belongs to the provider of this service. For example, service user data 48 for the “book selling” service provided by the service provider computer 22 contains the following information:
books already ordered by a service user,
an identifier for the service user, and
details of invoices in connection with book purchases not yet settled by the service provider.

The service user profile 46 is encrypted using a public key S1-E (encryption). When reading the service user profile 46 from the database 40, the data is decrypted using a secret private key S1-D (decryption). Both keys S1-E and S1-D are partner keys of an asymmetric encryption method. The private key S1-D can be kept secret by structural and/or electronic measures in the central computer 12.

The service user data 48 is encrypted in the service provider computers 22 to 26 using public keys (that differ from each other) of the individual service providers, see for example the public keys S2-E or S3-E in the service provider computers 22 or 24. The encrypted service-service user data is then transmitted via the connection 42 or 44 and stored encrypted in the database 40. The service user data 48 can also be read encrypted from the database 40 and transmitted encrypted via connection 42 or 44 to a service provider computer 22 or 24 where it is decrypted using a partner key S2-D or S3-D.

FIG. 2 shows a method for providing the “book purchasing” service by the service provider computer 22. If service user A wants to purchase a book, he establishes a connection between his service user computer 18 and the central computer 12, more precisely with the access unit 36 of the central computer 12. An authentication procedure 60, whereby a user identification of service user A is requested by the access unit 36, is performed between the service user computer 18 and access unit 36. Using the user identification, a public key S4-E is determined that is the partner key to the key S4-D of service user A stored in the smart card 20. The data coming from the service user computer 18 is encrypted using the public key S1-E of the central computer 12. The access unit 36 decrypts this data using the private key S1-D. The data transmitted from the access unit 36 to the service unit computer 18 is, on the other hand, encrypted in access unit 36 using public key S4-E and then transmitted via the Internet 14 to the service user computer 18. A private key S4-D stored in smart card 20 is used in the service user computer 18 to decrypt the data coming from the access unit 36. Before using the public key S4-E, the access unit 36 checks whether this key is still valid. The access unit 36 then requests a service user profile NP-A of service user A from the database 40, see arrow 62. Using the data stored in the service user profile NP-A, the access unit 36 provides the service user A with a selection list containing addresses of service provider computers that he frequently selects. The Internet address of the service provider computer 22 is also marked in this list.

From the list, the service user A selects a service provider computer, for example service provider computer 22, see arrow 64. In a next method step 66, a secure transmission channel is established between the service user computer 18 and service provider computer 22. The service provider computer 22 transmits its public key S2-E and a certificate ZB for its official key S2-E to the service user computer 18. The certificate for the public key S2-E is checked in service user computer 18. Let us assume that certificate ZB is genuine.

The service user A uses the public key S2-E to encrypt the data it is to send. Furthermore, the service user computer 18 transmits its public key S4-E and a reference to a certificate for public key S4-E, for example a reference to the PKI center 28 or a reference to the central computer 12. The service provider computer 22 checks the certificate using at least one public key that it trusts. Let us assume that the certificate is genuine. Data from the service provider computer 22 is therefore encrypted using the public key S4-E.

To preclude replay attacks and man-in-the-middle attacks, as they are called, a challenge-response procedure is put in place when setting up the secure transmission channel 66, with random numbers that change each time a connection is set up being exchanged between the service user computer 18 and service provider computer 22.

The service user A selects a book using the secure transmission channel and signals his interest in purchasing by pressing a button. Between the service provider computer 22 and central computer 12 a connection is then set up, more exactly between the service provider computer 22 and access unit 36 of the central computer 12.

The authorization of the service provider computer 22 is checked in a method step 68. For this check, the service provider computer 22 provides a certificate ZB for its public key S2-E to the access unit 36. The access unit 36 checks the certificate ZB.

The data from the service provider computer 22 is encrypted with the aid of the public key S1-E of the central computer 12. The central computer 12 can decrypt this data using its private key S1-D.

The central computer 12 also sends a certificate for its public key S1-E to the service provider computer 22. Before using this key S1-E, the service provider computer 22 checks the certificate for the public key S1-E.

The service provider computer 22 now requests customer data KD-A of the service user A from the central computer 12. In a method step 70, the customer data KD-A is read from the database 40 and transmitted to the service provider computer 22. During this process, the customer data KD-A is encrypted once, i.e. with the public key S2-D.

On the basis of the customer data KD-A, the service provider computer 22 automatically draws up a purchase contract. The contract data is signed by the service user computer 18 after entry-of a PIN (Personal Identity Number), a TAN (Transaction Number) or a biometric feature using the private key S4-D. The service provider computer 22 of the service provider B also signs the contract data using his private key S2-D. The signed data is exchanged between the service user computer 18 and service provider computer 22 via the secure transmission channel.

The signature of the service user computer 18 is checked in the service provider computer 22. The public key S4-E can be used for this purpose. Let us assume that the signature is genuine. The service user computer 18 checks the signature of the service provider computer 22 using the public key S2-E.

In a method step 74, the service provider computer 22 submits a request for payment by service user A and states the amount for which service user A has purchased books from it, for example, DM 300. The request and the amount are undersigned by a signature SignB using the private key S2-D.

The test unit 38 checks the signature SignB using the public key S2-E. Let us assume that the signature is genuine. Using a procedure explained in more detail with the aid of FIG. 3, the test unit 38 checks whether a credit institute has undertaken to provide cover, whether the amount is within the limit of a credit agreement with the credit institute or whether service user A has given his permission for the immediate deduction from his account. Let us assume that permission for immediate deduction is present. Therefore, the test unit 38 now creates a payment attribute using a method explained using FIG. 4. The test unit 38 then deducts the amount of DM 300 from the account of service user A and transfers the amount to a-trust account, in order to transfer it later to the operator of the service provider computer B.

In a method step 76, a payment attribute is transmitted to the service provider computer 22, in which it is confirmed that service user A is paying, or has paid, the amount of DM 300. The payment attribute is signed using the private key S1-D of the central computer 12 and transmitted to the service provider computer 22, if necessary also in encrypted form.

In a method step 78, the service provider computer 22 confirms to the service computer user 18 that the order has been accepted and delivery of the books activated. The secure transmission channel between the service provider computer 22 and service user computer 18 is used to transmit the order confirmation.

In a method step 80, the service provider computer 22 archives in database 40 the data relevant to the purchase contract, encrypted if necessary.

The following further method steps 82 are indicated by dots. By means of a logistics system, service provider computer 22 initiates the delivery of the book to service user A. On the transfer of the book, service user A confirms receipt. Confirmation is transmitted to the central computer 12, for example through the mobile radio network 16 using an SMS (Short Message Service) message, and there it is stored for subsequent verification purposes. At the same time, the amount of DM 300 is transferred from the trust account to an account of the service provider B.

FIG. 3 shows the processing of an ability-to-pay request. The ability-to-pay request is submitted from the test unit 38 to a bank computer 100 belonging to a credit institute or a bank. The ability-to-pay request is shown by an arrow 102 and contains details of the service user A and of the amount. The bank computer 100 checks whether an undertaking to provide cover can be given. In the exemplary embodiment, this is the case and by means of a piece of information 104 the bank computer 100 tells the test unit 38 that the service user A has given permission for immediate deduction from his account. In another exemplary embodiment, the bank computer 100, for example, states that the service user has a credit limit of ten thousand deutschmarks.

To prevent misuse, digital keys of an infrastructure and associated certificates can also be used for the transmission of the ability-to-pay request 102 and the transmission of the piece of information 104. In an exemplary embodiment, the data exchanged between the test unit 38 and bank computer 100 is encrypted using a digital encryption method.

The piece of information 104 from the bank computer 100 is stored in the service user profile 46. This information is confidential and is not made available to the service provider computer 22.

FIG. 4 shows the processing of a payment attribute request 122 that, after receipt of the piece of information 104 from the test unit 38, is directed to a payment attribute server 120, also known as a TrustedA computer. For example, a TrustedA computer from the company SSE is used, see www.sse.ie.

The payment attribute request 122 mainly contains the following data:
The amount of DM 300,
The name of the test unit 38 that has requested the payment attribute,
The name of the service provider computer 22 for which the payment attribute is determined.

The payment attribute server 120 produces a payment attribute 124 by means of which the following data is certified, i.e. provided with a digital SignAS signature of the attribute server:
The amount of DM 300,
The name of the test unit 39 that requested the payment attribute 124,
The name of the service provider computer 22 for which the payment attribute 124 is determined, and
Expiry data.

The payment attribute is communicated from the attribute server 120 to the test unit 39 in a method step 124. The test unit checks the details and the SignAS signature with the aid of a public key, that is classified as confidential.

In an exemplary embodiment, the service provider computer 22 also checks that the payment attribute 124 is genuine. The sale is confirmed only if the payment attribute is genuine.

The units explained with the aid of FIGS. 1 to 4 can be realized with the aid of programs. Circuit units are also used but without a processor. The functions of the central computer 12 can also be divided amongst several computers that are located at different points of the data transmission network 10.

In another exemplary embodiment, different keys are used to encrypt the data between the central computer 12 and service provider computer on one hand and for encrypting the service user data 48 to be stored in the database 40. The double encryption of the transmission on connections 42 and 44 enables security to be further increased.

Before awarding access authorization, the service providers are checked for trustworthiness by the operator of the central computer 12. New service users are also checked for trustworthiness. The acceptance of the explained method can be further increased by this procedure, both from the point of view of the service providers and the service users.

In a further exemplary embodiment, the functions of the TrustedA computer 120 are provided by the central computer 12. If in a next exemplary embodiment the central computer 12 is operated by a bank, the functions of the bank computer 100 can also be provided by the central computer 12.

In another exemplary embodiment, the functions of the central computer 12 are provided by several computers that are linked together via the Internet 14 or via dedicated lines.

1. A method for providing services in a data transmission network, comprising:
enabling a connection between one of several service user computers and one of several service provider computers, which can be selected by a service user depending on requests from one of the service user computers with an access function;
storing secure user data for the service users being stored in a central database, the secure user data being necessary for the provision of services of service provider computers;
after establishing a connection between a service user computer and a selected service provider computer, as part of the service provision for the service user using the service user computer, submitting a request that can be processed only by using the secure user data of a service user to a test unit used by several service provider computers;
transmitting the result of the processing to the service provider after the request has been processed by the test unit by accessing the secure user data of the service user; and
providing a service by the service provider computer depending on the processing result.

2. The method in accordance with claim 1, wherein the service provider computers belong to various operators, further comprising:
checking a selected service provider's authorization to submit a request using an authorization check procedure, and
transmitted transmitting the processing result only if authorization exists.

3. The method in accordance with claim 1, wherein the secure user data is stored encrypted,
and the service provider computer has no access to the digital key necessary for decrypting the secure user data.

4. The method for providing services in a data transmission network according to claim 1 wherein
service user data containing service-related data for the service users of individual service provider computers is stored in a database,
after selection of a service provider computer its authorization to receive service user data relevant to the service it provides is checked,
if authorization is present the service user data of the particular service user that selected the selected service provider computer is transmitted to the selected service provider computer,
and the service provider computer provides its service by using the transmitted service user data.

5. The method in accordance with claim 4, wherein the service user data is stored and transmitted encrypted,
and different service provider computers use different digital keys for decrypting service user data.

6. The method in accordance with claim 4, wherein the service user data is encrypted using a central encryption process,
and for encryption in accordance with the central encryption process, the same digital key is used for the service-service user data of different service provider computers.

7. The method in accordance with claim 4, wherein digital data regarding payment procedures for different service provider computers is stored in a database used by several service provider computers.

8. The method according to claim 1, wherein, the authorization of the service user is checked by using an authorization check procedure,
and the selection is allowed only if authorization is present.

9. The method in accordance with claim 1, wherein the authorization check is performed using digital keys that have been generated by at least one certification center,
and the certification center is part of a certification infrastructure.

10. The method in accordance with claim 9, wherein a secret digital key is used for encryption,
and the secret digital key is stored in an electronically protected storage unit.

11. The method in accordance with claim 10, wherein the protected storage unit is part of a chip card with a processor,
and the protected storage unit can be accessed after an authorization check only by the processor.

12. The method in accordance with claim 1, wherein the request refers to the securing of a payment.

13. The method in accordance with claim 12, Wherein the test unit, when processing the requirement, submits a request to a certification computer to receive a payment certificate,
the certifying computer generates a digital payment certificate that secures the payment,
and the payment certificate is transmitted via the test unit to the service provider computer.

14. The method in accordance with claim 12, wherein the test unit, when processing the request, generates a payment certificate that secures the payment,
and the payment certificate is transmitted to the service provider computer.

15. The method in accordance with claim 13, wherein the payment certificate is generated with the aid of a digital key.

16. The method in accordance with claim 1, wherein the service provider computers perform the function of electronic sales platforms for various products or product groups and/or electronic service provision platforms for various services or service groups.

17. A computer readable medium upon which is stored a program with an instruction sequence that when executed by a processor performs the method of claim 1.

18. A data processing system characterized by a program in accordance with claim 17.
